(19) United States
(12) Patent Application Publication
(10) Pub. No.: US 2018/0181531 A1
(43) Pub. Date: Jun. 28, 2018

(54) SERIAL PERIPHERAL MODE IN MIPI IMPROVED INTER-INTEGRATED CIRCUIT (I3C)

(71) Applicant: Intel Corporation, Santa Clara, CA (US)

(72) Inventors: Kenneth P. Foust, Beaverton, OR (US); Duane G. Quiet, Hillsboro, OR (US); Amit Kumar Srivastava, Penang (MY)

(21) Appl. No.: 15/466,315

(22) Filed: Mar. 22, 2017

Related U.S. Application Data
(60) Provisional application No. 62/437,969, filed on Dec. 22, 2016.

(51) Int. Cl. G06F 13/42; G06F 13/36; G06F 13/40

(52) U.S. Cl. CPC G06F 13/4282; G06F 2213/0016; G06F 13/4068; G06F 13/36

(57) ABSTRACT

Embodiments of the present disclosure may relate to an I3C bus master that is to identify that an I3C bus with which the I3C bus master is coupled is to enter a serial peripheral interface (SPI) high data rate (HDR) mode. The I3C bus master may be further to communicate, in accordance with the SPI HDR mode, with an SPI slave device via an I3C serial data (SDA) line, an I3C serial clock (SCL) line, and a selection line. Other embodiments may be described and/or claimed.

### CROSS REFERENCE TO RELATED APPLICATIONS

This application claims priority under 35 U.S.C. § 119(e) to U.S. Provisional Patent Application No. 62/437,969 entitled “SERIAL PERIPHERAL MODE IN MIPI I3C,” filed Dec. 22, 2016, the disclosure of which is incorporated herein by reference.

### FIELD

Embodiments of the present disclosure generally relate to the field of MIPI device communication and, more specifically, inclusion of legacy communication techniques in next generation MIPI standards.

### BACKGROUND

The MIPI® Alliance has developed an interface referred to as improved inter-integrated circuit (I3C)℠, which may relate to sensor needs in mobile and mobile influenced industries. In legacy networks, sensors may be connected to bus masters, host controllers and/or application processors via inter-integrated circuit (I²C)℠ interface busses. However, some sensors, which have historically required bandwidths beyond those achieved by I²C fast mode (FM) (i.e., a bandwidth of approximately 400 Kilohertz (KHz)) and I²C FM plus (FM+) (i.e., a bandwidth of approximately 1 Megahertz (MHz)), may have used a serial peripheral interface (SPI) communication protocol rather than a MIPI communications protocol. These sensors may continue to use the SPI communication protocol.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 is an example of a MIPI I3C bus with I²C, I3C, and SPI devices, in accordance with various embodiments.

FIG. 2 is an example process flow for SPI mode on an I3C bus, in accordance with various embodiments.

FIG. 3 is an example signal diagram of a high data rate (HDR) SPI mode on an I3C bus, in accordance with various embodiments.

FIG. 4 is an alternative example signal diagram of an HDR SPI mode on an I3C bus, in accordance with various embodiments.

FIG. 5 is a block diagram of an example computing device, in accordance with various embodiments.

FIG. 6 illustrates an example storage medium with instructions configured to enable an apparatus to practice various aspects of the present disclosure, in accordance with various embodiments.

### DETAILED DESCRIPTION

Embodiments of the present disclosure may relate to an I3C bus that is coupled with one or more I3C or I²C devices, and an SPI slave device. The I3C bus may include an I3C serial data (SDA) line and an I3C serial clock (SCL) line. The I3C bus may further include a selection line and (optionally) a slave device out (SDO) line that are coupled with the SPI slave device; however, the selection line and the SDO line may not be coupled with the I3C or I²C devices. The I3C bus master may be able to configure the I3C bus with an HDR SPI that allows the I3C bus master to communicate with the SPI slave device via the SDA line, the I3C SCL line, the selection line, and (optionally), the SDO line.

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. It will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

In various embodiments, the phrase “a first layer formed, deposited, or otherwise disposed on a second layer” may mean that the first layer is formed, deposited, grown, bonded, or otherwise disposed over the second layer, and at least a part of the first layer may be in direct contact (e.g., direct physical and/or electrical contact) or indirect contact (e.g., having one or more other layers between the first layer and the second layer) with at least a part of the second layer.

As used herein, the term “module” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality.

Embodiments herein relate to the use of 3-wire or 4-wire device operation on the MIPI I3C interface bus. Specifically, the 3-wire or 4-wire device operation may allow for a single I3C bus master and one or two SPI pins to be reused while coexisting with I3C. More specifically, embodiments herein may advance the MIPI I3C bus by specifying how the 3-wire and 4-wire interface lines may be managed during native I3C bus operation, and during 3-wire or 4-wire SPI operation. This 3-wire or 4-wire SPI operation may allow for legacy SPI devices to coexist with I3C, which may reduce I3C bus master and pin cost. Additionally embodiments may introduce a command by which to enter HDR mode, thereby accommodating SPI operation. More specifically, embodiments herein relate to both physical network and protocol layer techniques by which SPI slave device support can be added to MIPI I3C.

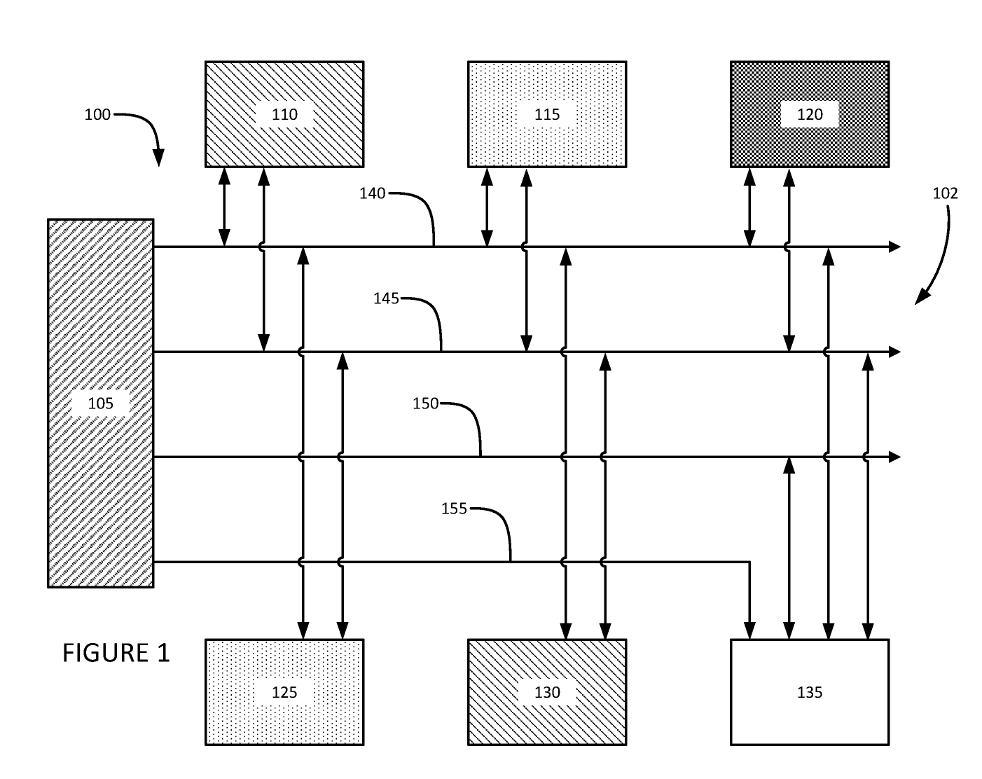

For example, FIG. 1 depicts an example of a system 100 that includes a MIPI I3C bus 102 with I²C, I3C, and SPI devices, in accordance with various embodiments. Generally, it may be desirable for an SPI slave device to communicate with an I3C bus master using 3 or 4 wires. As such, in legacy embodiments, the SPI slave devices may have existed on their own dedicated system pins connected to an SPI-specific host controller. Such a configuration may require additional cost both in terms of space and component cost, both of which may be at a premium in mobile device environments.

However, as shown in FIG. 1, on example embodiment herein of a system 100 that may include a 4 wire MIPI I3C bus 102. Specifically, the bus 102 may include an SDA line 140, an SCL line 145, an SDO line 150, and a selection line 155. The system 100 may include a variety of devices coupled with the bus 102. For example, the bus 102, and particularly the SDA line 140, the SCL line 145, the SDO line 150, and the selection line 155, may be communicatively coupled with an I3C bus master 105 (which may also be referred to as an I3C main master or a host controller). The SDA line 140 and the SCL line 145 may also be coupled with a variety of I3C devices such as one or more I3C secondary masters 110 and 130, one or more I3C slaves 115 and 125, and an I²C slave 120. The system may further include an SPI slave device 135 that is coupled with the I3C bus master 105 via the SDA line 140, SCL line 145, SDO line 150, and the selection line 155.

Generally, the I3C bus master 105 may be configured to receive data from, or transmit data to, the I3C devices by way of the SDA line 140 when the system 100 is operating in an I3C single data rate (SDR), an I3C HDR-dual data rate (DDR) mode, a ternary symbol pure bus (TSP), a ternary symbol legacy inclusive bus (TSL), or some other I3C mode. Similarly, the I3C bus master 105 may be configured to receive data from, or transmit data to, the I²C slave 120 when the system is operating in an I²C mode. Generally, the SCL line 145 may carry clock signals from the I3C bus master 105 to the various devices coupled with the bus 102, and the devices may read the data on the SDA line 140 based on the clock signals. For example, the signals on the SCL line 145 may oscillate between a high state and a low state at a pre-configured frequency. As used herein, the “high state” refers to a logical 1 where the voltage on the line is high. The “low state” refers to a logical 0 where the voltage on the line is low. The data on the SDA line 140 may be read in accordance with the rising edge of the clock signal(s), that is, when the signals are changing from a low state to a high state.

The I3C bus master 105 may be configured to control the actions of the various devices coupled with the bus 102. For example, the I3C bus master 105 may transmit signals between a device on the bus 102 and another component of the system 100. In some embodiments, these signals may be indications of the data generated by the device on the bus 102 if the device is a sensor or some other peripheral device. The I3C bus master 105 may also direct the various devices to perform one or more actions or measurements. For example, the I3C slave device(s) 115/125 and/or the I²C slave device 120 may be or include a sensor such as an accelerometer, a gyroscope, a magnetometer, a proximity sensor, a compass, a grip sensor, a sensor related to near field communication, an altimeter, some combination thereof, etc. Additionally or alternatively the I3C slave device(s) 115/125 and/or the I²C slave device 120 may be or include some other type of peripheral device. In some embodiments, the I3C secondary master(s) 110/130 may be to receive, relay, and/or buffer commands or data between the I3C bus master 105 and the various other devices coupled with the bus 102.

As shown in FIG. 1, the system 100 may further include an SPI slave device 135 coupled with the I3C bus master 105 via the SDA line 140, the SCL line 145, the SDO line 150, and the selection line 155. The SPI slave device 135 may be, for example, a fingerprint sensor, an analog-to-digital converter, or some other type of SPI device. As explained in greater detail below, the I3C bus master 105 may be able to communicate with the SPI slave device 135 via an HDR SPI mode.

When the I3C bus master 105 is communicating with the SPI slave device 135 via the HDR SPI mode, the SDA line 140 may act as a slave device input (SDI) line, that is, a line by which the I3C bus master 105 can send one or more control or data signals to the SPI slave device 135. The SPI slave device 135 may be configured to transmit one or more signals to the I3C bus master 105 via the SDO line 150. The selection line 155 may be configured to act as an indicator that the I3C bus master 105 and the SPI slave device 135 are to communicate via the HDR SPI mode. In embodiments, the selection line 155 may be an active high chip select (CS) line or an active high slave select (SS) line, that is, a line where a steady digital “one” signal indicates that the line is active. Alternatively, the selection line 155 may be an active low chip select (nCS) line, that is, a line where a steady digital “zero” signal indicates that the line is active.

As used herein, “active” may mean that the line is being monitored for meaningful data transmission. By contrast, as used herein, “inactive” may mean that the line is not being monitored. For example, an inactive line may be high, low, or transitioning from high to low (or vice versa), and a device with that line will not identify such a status as indicative of a transmission from another device on that line.

By selectively entering the HDR SPI mode, the I3C bus master 105 may communicate with the SPI slave device 135 in accordance with an HDR SPI mode when the SPI slave device 135 is coupled with the bus 102, as opposed to legacy devices where a separate bus may have been used specifically for communicating with the SPI slave device.

In some embodiments, the I3C bus master 105 may identify that it is to enter the HDR SPI mode and begin the process of doing so, as described in greater detail below. For example, the I3C bus master 105 may identify that it has data to send to the SPI slave device 135. Such data may be, for example, based on a request from a user of the system 100, a request from another component of the system 100 or a component coupled with the system 100 (e.g., another peripheral device, a processor, etc.), or some other data. Additionally or alternatively, the I3C bus master 105 may identify that it is to enter the HDR SPI mode based on a request received from the SPI slave device 135, for example, via the SDA line 140. Such a request may be because the SPI slave device 135 may have identified that it has data to share with the I3C bus master 105 or some other component of the system or a component coupled with the system. For example, the SPI slave device 135 may be a type of sensor that periodically monitors a given condition (e.g., an accelerometer, etc.), or the SPI slave device 135 may have detected a change in a condition that it monitors. In these instances, the SPI slave device 135 may send a request to the I3C bus master 105 to enter the HDR SPI mode so that the SPI slave device 135 can share the data.

It will be understood that the embodiment of the system 100 is intended as one example, and other embodiments may include more or fewer devices coupled with the bus 102. For example, although only a single SPI slave device is depicted coupled with the bus 102, in other embodiments the system 100 may include a plurality of SPI slave devices. Similarly, the system 100 may include more or fewer I3C and/or I²C devices than shown in FIG. 1.

Additionally, in some embodiments, only 3 lines may be used for the HDR SPI mode. For example, in these embodiments the SDO line 150 may be omitted. Rather, the SDA line 140 may be used as a slave device input/output (SDI/0) line by which the I3C bus master 105 and the SPI slave device 135 can communicate between one another. In this embodiment, the SDO line 150 may still be present, but it may be inactive as described above such that a signal (either high, low, or a combination thereof) is not indicative of a transmission from another device coupled with the line.

In embodiments wherein the system 100 is used to couple an SPI slave such as SPI slave device 135 to an I3C bus such as I3C bus 102, specific I3C protocol capabilities may be desirable for the I3C bus 102 to function. In legacy I3C systems, three HDR modes such as HDR-DDR, HDR-TSL, and HDR-TSP may be used to allow the I3C bus master 105 to interface with I3C slave devices in alternate manners that non-supported devices on the I3C bus 102 ignore, regardless of SCL clocking speed generated by the I3C bus master 105. A non-supported device may be, for example, a legacy I²C device, an I3C device that does not support the HDR mode, or some other device. For example, if a non-supported device such as a legacy I²C device is present on the I3C bus 102, then an internal spike filter (i.e., a 50 nanoseconds (ns) spike filter) may filter out toggling from high to low (or vice versa) on the SDA line 140 in the HDR mode such that the legacy I²C is not aware of line toggling.

In embodiments where the system 100 is to use the HDR SPI mode, it may be desirable for the I3C bus master 105 to be able to inform all devices on the I3C bus 102 that the system is transitioning to the HDR SPI mode, and thus non-supporting devices shall ignore activity on the I3C bus 102 until the non-supporting device identifies a pre-defined exit common command code (CCC) on the I3C bus 102. The exit CCC may be an indication that can be used by the I3C bus master 105 to indicate that use of the HDR SPI mode is being ended. Similarly, a CCC may be used by the I3C bus master 105 to indicate that the system is entering the HDR SPI mode. Such a CCC may be referred to herein as an “EnterHDRx” CCC. An example frame of an I3C transaction that includes use of the HDR SPI mode may be as follows:

| | | | HDR SPI | | | HDR SPI | | | |
|---|---|---|---|---|---|---|---|---|---|
| I3C | | | Msg1 | | HDR SPI | Msg2 | | I3C | |
| START | Brdcst | EnterHDRx | Cmd | Data | HDR | Cmd | Data | HDR | STOP |
| | | | | | Restart | | | Exit | |
| | | | | | Pattern | | | Pattern | |
| | | | | | (optional) | | | | |

### Example HDR SPI Frame

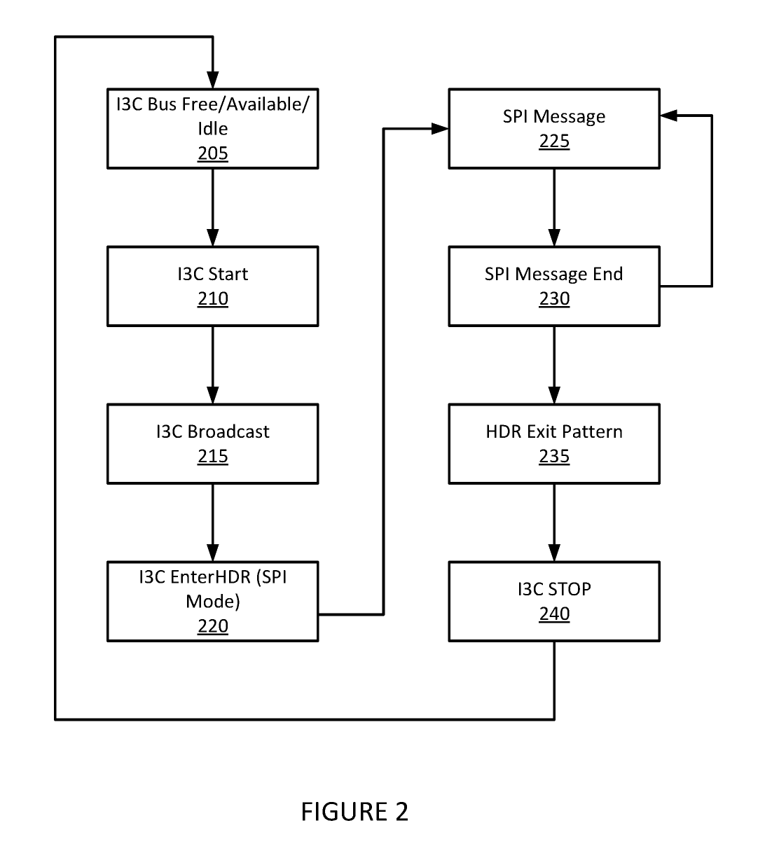

By use of the Example HDR SPI frame, above, SPI may be supported on the I3C bus 102 via the example process flow depicted in FIG. 2.

Initially, as shown at element 205, the I3C bus 102 may be “idle.” As used herein, “idle” may refer to a state where there are no signals being transmitted on the I3C bus 102. Other terms similar to “idle” may be, for example, “free,” or “available.” Generally, the idle state may be designated by the SDA line 140 and the SCL line 145 being at a high state. The SDO line 150 and the selection line 155 may be in an inactive state.

The frame may then be begun by use of a CCC such as “START,” as shown at element 210. Specifically, the “START” CCC may be broadcast by the I3C bus master 105 at 210 to indicate that an I3C frame is to follow. The “START” command may be indicated by switching the SDA line 140 to a low state while the SCL line 145 remains at a high state.

The “Brdcst” CCC may then be used by the I3C bus master 105 to indicate that data is to be transmitted at element 215. To transmit the “Brdcst” CCC, both the SDA line 140 and the SCL line 145 may be in an active state. As noted above, the SDA line 140 may be read by a device on the I3C bus 102 by identifying the state of the SDA line 140 (high or low) based on a prompt of the SCL line 145. Such a prompt may be, for example, when the SCL line 145 goes from a low state to a high state, or vice versa.

The “EnterHDRx” CCC may then indicate that a specific I3C HDR mode, that is, the HDR SPI mode, is to be entered by the system at 220. Specifically, the I3C bus master 105 may transmit the “EnterHDRx” CCC as data on the SDA line 140 that is identified by a device on the I3C bus 102 as discussed above. As noted above, once a non-supporting I²C or I3C device such as I3C secondary master(s) 110/130, I3C slave device(s) 115/125, I²C slave device 120, or some other device that does not support SPI, identifies the EnterHDRx CCC, then the device may cease to monitor the SDA line 140 until such time as the device identifies a predefined exit pattern CCC. Once the SPI HDR mode is entered, the SDA line 140 may operate as an SDI line, as discussed above.

Once the SPI HDR mode is entered, both the I3C bus master 105 and any SPI device such as SPI slave device 135 may treat each of the SDA line 140, the SCL line 145, the SDO line 150, and the selection line 155 as active. That is, each of the lines may be identified as carrying meaningful information. For example, the I3C bus master 105 and/or the SPI slave device 135 may transmit all or part of an SPI message at 225. Such a message may be in accordance with, for example, legacy SPI message standards, or the message be in accordance with an SPI standard hereinafter developed. The SPI message may include, for example, a command (“Cmd”) and a data part as shown in the example HDR SPI frame above as bolded and underlined. Specifically, the HDR SPI message may start with a “Cmd” element indicating that an HDR SPI message is to follow, and then a “Data” element of the HDR SPI message may be transmitted. In embodiments, the SPI message may be transmitted either by the I3C bus master 105 along the SDI line (i.e., the SDA line 140 operating as an SDI line), or by the SPI slave device 135 along the SDO line 150.

Once the transmission of the SPI message at 225 is complete, the SPI message may end at 230. The end of the SPI message may be signaled, for example, by the SDO line 150 and selection line 155 entering an inactive state where they are not actively transmitting data. If there are other SPI messages to be transmitted (e.g. HDR SPI Msg2 in the example HDR SPI frame above), then the example process flow may return to element 225. In some embodiments, the I3C bus master 105 may transmit an HDR restart pattern which may be similar to the “EnterHDRx” CCC discussed above. Such a restart pattern may indicate that the devices coupled with the I3C bus 102 are to remain in, or re-enter, the HDR SPI mode.

After all SPI messages have been transmitted at 225 and 230, the I3C bus master 105 may transmit a predefined exit pattern CCC at 235. Such a pattern may be identified by the SCL line 145 being held at a low state, while the exit pattern is transmitted on the SDA line 140. The exit pattern CCC may serve to alert other devices on the bus 102 that the system 100 is exiting the HDR SPI mode, and the devices should resume monitoring the SDA line 140 for an I²C or I3C transmission. The SDO line 150 and the selection line 155 may become inactive.

The “STOP” CCC may then be transmitted by the I3C bus master 105 at 240 to indicate the end of the I3C frame. The “STOP” CCC may be transmitted by holding the SDA line 140 and SCL line 145 at “high” while the SDO line 150 and selection line 155 remain inactive.

It will be understood that the names of specific CCCs or patterns described herein are intended as examples. For example, in other embodiments the “EnterHDRx” CCC may have a different name, while still accomplishing a similar function. Additionally, the Example HDR SPI Frame is intended as one example, and in other embodiments the frame may be longer or shorter. For example, in some embodiments the HDR SPI Frame may omit one or more elements such as the HDR Restart Pattern or the HDR SPI Msg2. In other embodiments, the frame may include additional HDR SPI Messages, or include additional CCCs.

Additionally, it will be understood that the embodiment described above is described primarily with respect to a 4-wire implementation where the SDA line 140 serves as an SDI line such that the I3C bus master 105 can send data to the SPI slave device 135 in accordance with the HDR SPI mode. Similarly, in the 4-wire implementation, the SDO line 150 may allow the SPI slave device 135 to send data to the I3C bus master 105 in accordance with the HDR SPI mode. In other embodiments the SDO line 150 may not be present, or it may remain inactive. In these embodiments, as described above, the SDA line 140 may serve as an SDI/O line wherein the I3C bus master 105 may send information to, or receive information from, the SPI slave device 135 in accordance with the HDR SPI mode. Specifically, in such a 3-wire embodiment, the SDO line 150 may be inactive (or not present) during element 225.

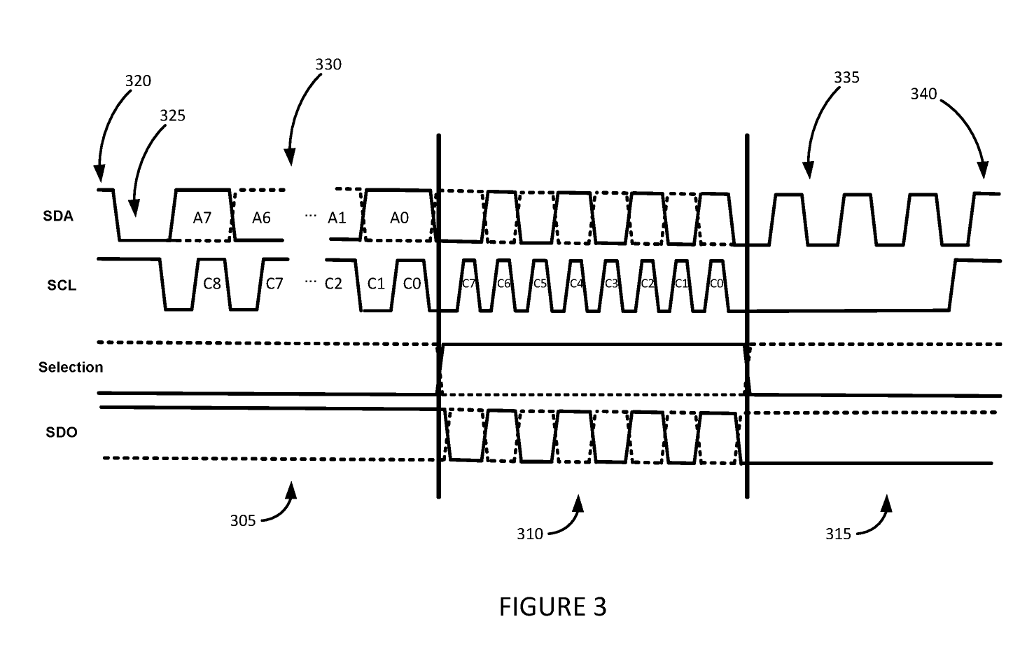

FIG. 3 depicts an example signal diagram of an SPI HDR mode on an I3C bus such as bus 102, in accordance with various embodiments. Specifically, FIG. 3 depicts an SDA line, an SCL line, a selection line, and an SDO line, which may be respectively similar to SDA line 140, SCL line 145, selection line 155, and SDO line 150.

For the purposes of discussion here, the signal diagram may be generally divided into 3 regions in accordance with the example SPI HDR frame depicted above. The division may be as depicted with the solid vertical lines. Generally, region 305 may correspond to the “START,” “Brdcst,” and “enterHDRx” CCCs as discussed above. Region 310 may generally correspond to the SPI HDR operation of the system and include, for example, the HDR SPI Msg1 and HDR SPI Msg2 as described above. Region 315 may generally correspond to the HDR Exit Pattern and the STOP CCC as discussed above.

As shown in FIG. 3, the SDA line and SCL line may be in a high state at 320, which may correspond to the “START” CCC and element 210 as described above. The SDA line may then transition to a low state while the SCL line remains at a high state at 325, which may generally correspond to the “Brdcst” CCC and element 215, as described above. Subsequently, the SCL line may begin oscillating at a pre-defined frequency while the SDA line transmits data at 330. Such data may be, for example, the “enterHDRx” CCC at element 220 and as discussed above. Although the selection and SDO lines are shown in region 305, as noted above these lines may be inactive in that any value they are at is not interpreted by the system as indicating an information transfer.

Subsequently, the bus may enter the HDR SPI mode in region 310. As discussed above, the SPI message may be transmitted via the SDA line, the SCL line, the selection line, and the SDO line.

Once the SPI message is transmitted in accordance with the HDR SPI mode, the predefined HDR exit pattern may be broadcast. Specifically, as described above with respect to element 235 above, the selection and SDO lines may go inactive, and the SCL line may be directed to a low state by the I3C bus master. The I3C bus master may then transmit a pre-defined pattern such as the 3 “high state” signals shown at 335. However, in other embodiments, the pre-defined pattern may be some other pattern. After the exit pattern is broadcast, the “STOP” CCC may be broadcast by moving the SDA line to the “high state” as shown at 340 and described above with respect to element 240.

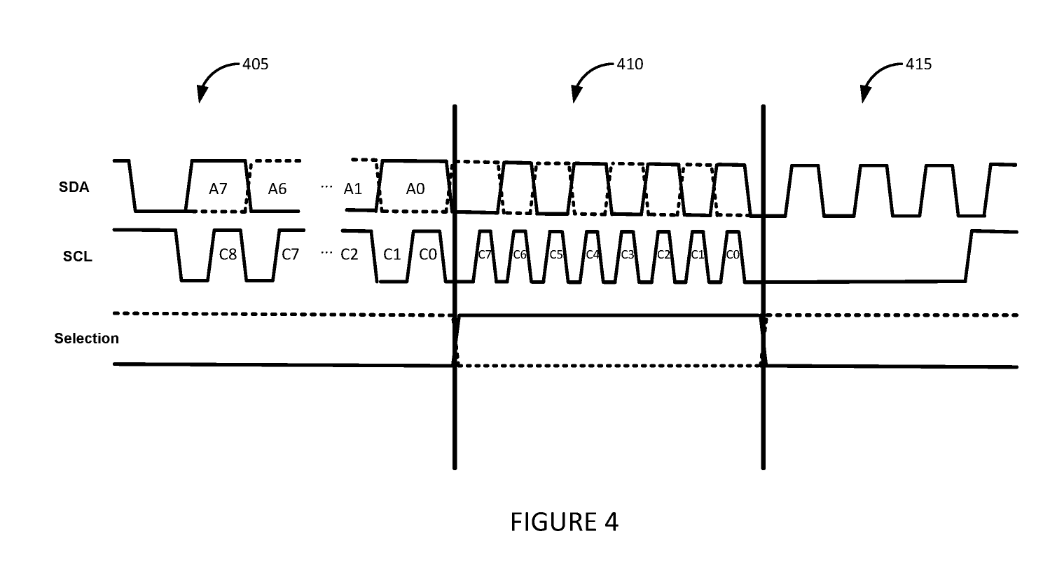

As noted above, FIG. 2 is described primarily with respect to a 4-wire bus where the SDO line is present. However, in some embodiments, the SDO line may not be present, or it may remain inactive. In these embodiments, the HDR SPI mode may operate over 3 wires (the SDA line, the SCL line, and the selection line). Such a mode of operation is depicted in FIG. 4. Region 405 may generally correspond to region 305; region 410 may generally correspond to region 310; and region 415 may generally correspond to region 315. Remaining elements that may correspond, for example, to elements 320, 325, 330, 335, and 340 are not renumbered for the sake of redundancy.

It will be understood that although portions of the data transfer, for example, on SDA line within region 310 or 410, are depicted as pure oscillations, in other embodiments the SDA line may remain at a single state (i.e., a “high state” or “low state”) for 2 or more consecutive oscillations. Additionally, it will be noted that in some embodiments the SDA line or SDO line may be an “active high” or “active low” line. Therefore, those two states are depicted by the solid and dashed lines of FIG. 3.

Rules related to the use of the HDR SPI mode may be performed with respect to the following guidelines. It will be understood that these guidelines are merely examples, and other embodiments may deviate from one or more of the following guidelines:

1) A selection line such as selection line 155, regardless of its polarity (active high or active low), may be in an inactive state during non-SPI HDR mode operation or conditions. Such conditions may include an I3C Bus Free condition, a Bus Available condition, a Bus Idle condition, I3C SDR mode, I3C HDR-DDR/TSL/TSP mode, or transmission of an HDR Enter/Exit pattern or CCC as described above.

2) SPI modes may be restricted to operating only as an I3C HDR mode. That is, SPI transactions may not occur on the bus outside of the I3C SPI HDR mode.

3) The SPI HDR mode may be entered in accordance with a legacy I3C operation through use of the “enterHDRx” CCC.

4) Once the system enters the SPI HDR mode, the I3C bus master (e.g., I3C bus master 105) may begin transmitting an indication of a preferred SPI mode over the I3C bus by first transitioning a selection line (e.g., selection line 155) to an active state. This transition of the selection line to the active state may address the SPI slave device (e.g., SPI slave device 135) with which the I3C bus master is to communicate.

5) During SPI transmission, the I3C bus master may not exceed the maximum clock frequency at which the SPI slave device (e.g., SPI slave device 135) is to operate.

6) The I3C bus master may be able to activate or deactivate the selection line more than once. This activation/deactivation may allow the I3C bus master to initiate multiple SPI transactions with multiple SPI devices. However, in some embodiments, the I3C bus master may only be able to perform one read transaction at a time.

7) The I3C bus master may return the selection line to an inactive state prior to exiting the SPI HDR mode.

8) The I3C bus master may exit the SPI HDR mode through use of the exit HDR pattern and the “STOP” CCC.

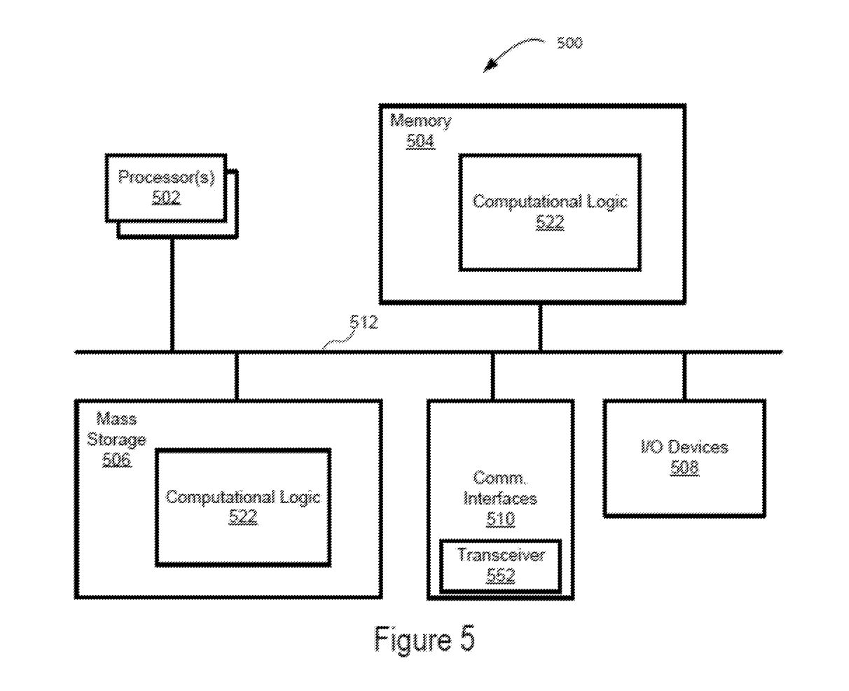

FIG. 5 illustrates a block diagram of an example computing device 500 suitable for use with various components of FIG. 1 and the technique of FIG. 2, in accordance with various embodiments. For example, the computing device 500 may include one or more I²C, I3C, or SPI devices. The computing device 500 may further include an I3C bus master such as I3C bus master 105, which may be similar to the processor(s) 502 of FIG. 5.

As shown, computing device 500 may include one or more processors or processor cores 502 and system memory 504. For the purpose of this application, including the claims, the terms “processor” and “processor cores” may be considered synonymous, unless the context clearly requires otherwise. The processor 502 may include any type of processors, such as a central processing unit (CPU), a microprocessor, and the like. The processor 502 may be implemented as an integrated circuit having multi-cores, e.g., a multi-core microprocessor. The computing device 500 may include mass storage devices 506 (such as diskette, hard drive, volatile memory (e.g., dynamic random access memory (DRAM), compact disc read-only memory (CD-ROM), digital versatile disk (DVD), and so forth). In general, system memory 504 and/or mass storage devices 506 may be temporal and/or persistent storage of any type, including, but not limited to, volatile and non-volatile memory, optical, magnetic, and/or solid state mass storage, and so forth. Volatile memory may include, but is not limited to, static and/or dynamic random access memory. Non-volatile memory may include, but is not limited to, electrically erasable programmable read-only memory, phase change memory, resistive memory, and so forth.

The computing device 500 may further include I/O devices 508 (such as a display (e.g., a touchscreen display), keyboard, cursor control, remote control, gaming controller, image capture device, and so forth) and communication interfaces 510 (such as network interface cards, modems, infrared receivers, radio receivers (e.g., Bluetooth), and so forth).

The communication interfaces 510 may include communication chips (not shown) that may be configured to operate the device 500 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long-Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 510 may operate in accordance with other wireless protocols in other embodiments. In various embodiments, the communication interfaces 510 may include a transceiver 552. In some embodiments, the transceiver 552 may be coupled with other components of the computing device 500 and/or may not be included within the communication interfaces 510.

The above-described computing device 500 elements may be coupled to each other via system bus 512, which may represent one or more buses. In the case of multiple buses, they may be bridged by one or more bus bridges (not shown). Each of these elements may perform its conventional functions known in the art. In particular, system memory 504 and mass storage devices 506 may be employed to store a working copy and a permanent copy of the programming instructions for the operation of various components of computing device 500, including but not limited to an operating system of computing device 500 and/or one or more applications. The various elements may be implemented by assembler instructions supported by processor(s) 502 or high-level languages that may be compiled into such instructions.

The permanent copy of the programming instructions may be placed into mass storage devices 506 in the factory, or in the field through, for example, a distribution medium (not shown), such as a compact disc (CD), or through communication interface 510 (from a distribution server (not shown)). That is, one or more distribution media having an implementation of the agent program may be employed to distribute the agent and to program various computing devices.

The number, capability, and/or capacity of the elements 508, 510, 512 may vary, depending on whether computing device 500 is used as a stationary computing device, such as a set-top box or desktop computer, or a mobile computing device, such as a tablet computing device, laptop computer, game console, or smartphone. Their constitutions are otherwise known, and accordingly will not be further described.

In embodiments, memory 504 may include computational logic 522 configured to implement various firmware and/or software services associated with operations of the computing device 500. For some embodiments, at least one of processors 502 may be packaged together with computational logic 522 configured to practice aspects of embodiments described herein to form a System in Package (SiP) or a System on Chip (SoC).

In various implementations, the computing device 500 may comprise one or more components of a data center, a laptop, a netbook, a notebook, an ultrabook, a smartphone, a tablet, a personal digital assistant (PDA), an ultra mobile PC, a mobile phone, or a digital camera. In further implementations, the computing device 500 may be any other electronic device that processes data.

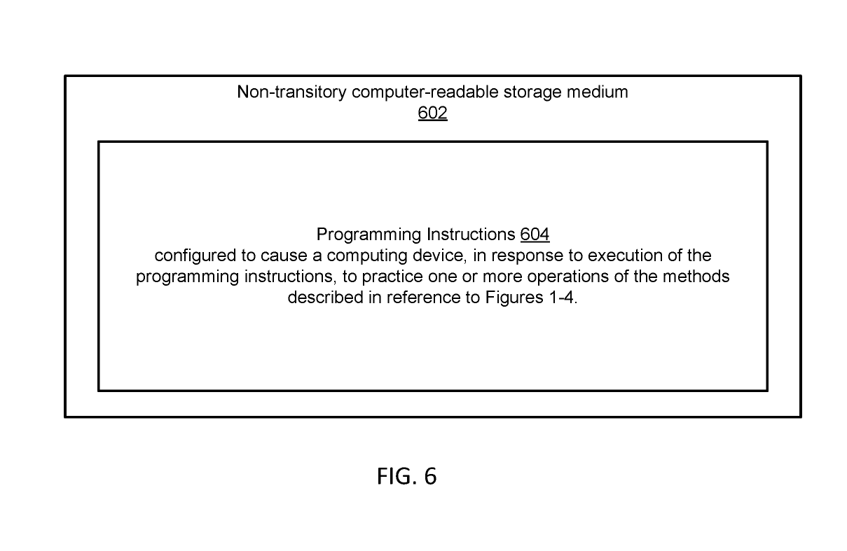

FIG. 6 illustrates example computer-readable storage medium 602 having instructions configured to practice all or selected ones of the operations associated with the computing device 500, earlier described with respect to FIG. 5; the system 100; and/or the technique of FIG. 2, in accordance with various embodiments. As illustrated, computer-readable storage medium 602 may include a number of programming instructions 604. The storage medium 602 may represent a broad range of non-transitory persistent storage media known in the art, including but not limited to flash memory, dynamic random access memory, static random access memory, an optical disk, a magnetic disk, etc. Programming instructions 604 may be configured to enable a device, e.g., computing device 500, I3C bus master 105, and/or some other device of FIG. 1, in response to execution of the programming instructions 604, to perform, e.g., but not limited to, various operations described for the elements of FIG. 1 or FIG. 5, or operations shown and/or described with respect to FIG. 2. In alternate embodiments, programming instructions 604 may be disposed on multiple computer-readable storage media 602. In alternate embodiment, storage medium 602 may be transitory, e.g., signals encoded with programming instructions 604.

Referring back to FIG. 5, for an embodiment, at least one of processors 502 may be packaged together with memory having all or portions of computational logic 522 configured to practice aspects shown or described for the system 100 shown in FIG. 1, or operations shown or described with respect to the technique of FIG. 2. For an embodiment, at least one of processors 502 may be packaged together with memory having all or portions of computational logic 522 configured to practice aspects described for the system 100 shown in FIG. 1, or operations shown or described with respect to the technique of FIG. 2 to form a System in Package (SiP). For an embodiment, at least one of processors 502 may be integrated on the same die with memory having all or portions of computational logic 522 configured to practice aspects described for the system 100 shown in FIG. 1, or operations shown or described with respect to the technique of FIG. 2. For an embodiment, at least one of processors 502 may be packaged together with memory having all or portions of computational logic 522 configured to practice aspects of the system 100 shown in FIG. 1, or operations shown or described with respect to the technique of FIG. 2 to form a System on Chip (SoC).

Machine-readable media (including non-transitory machine-readable media, such as machine-readable storage media), methods, systems and devices for performing the above-described techniques are illustrative examples of embodiments disclosed herein. Additionally, other devices in the above-described interactions may be configured to perform various disclosed techniques.

Example 1 may include a system comprising: one or more processors; and one or more non-transitory computer-readable media coupled with the one or more processors, wherein the one or more computer-readable media include instructions that, when executed by the one or more processors, cause an improved inter-integrated circuit (I3C) bus master of the system to: identify that an I3C bus with which the I3C bus master is coupled is to enter a serial peripheral interface (SPI) high data rate (HDR) mode; and communicate, in accordance with the SPI HDR mode, with an SPI slave device via an I3C serial data (SDA) line, an I3C serial clock (SCL) line, and a selection line.

Example 2 may include the system of example 1, wherein the instructions are further to cause the I3C bus master to use the SDA line as a slave device input/output (SDI/0) line to transmit data to, and receive data from, the SPI slave device.

Example 3 may include the system of example 1, wherein the selection line is an active low chip select (nCS), an active high chip select (CS), or a slave select (SS) line.

Example 4 may include the system of example 1, wherein the instructions are further to cause the I3C bus master to identify data received from the SPI slave device via a slave data out (SDO) line, and wherein the instructions are further to cause the I3C bus master to use the SDA line as a slave device input (SDI) line on which the I3C bus master is to transmit data to the SPI slave device.

Example 5 may include the system of any of examples 1-4, wherein the system is to enter the SPI HDR mode based on a request received from the SPI slave device.

Example 6 may include the system of any of example 1-4, wherein the instructions are further to cause the I3C bus master to transmit, via the SDA line, an indication that the I3C bus is to enter the SPI HDR mode.

Example 7 may include the system of example 6, wherein the instructions are further to cause the I3C bus master to transmit, via the SDA line, an indication that the I3C bus is to exit the SPI HDR mode.

Example 8 may include the system of example 7 and/or some other example herein, wherein the indication that the I3C bus is to enter the SPI HDR mode is to cause I3C or inter-integrated circuit (I²C) devices on the SDA line to become unresponsive to signals on the SDA line until they identify receipt of the indication that the I3C bus master is to exit the SPI HDR mode.

Example 9 may include a system comprising: a serial peripheral interface (SPI) slave device; an improved inter-integrated circuit (I3C) bus master; and an I3C bus that includes: an I3C serial data (SDA) line that communicatively couples the I3C bus master to the SPI slave device; an I3C serial clock (SCL) line that communicatively couples the I3C bus master to the SPI slave device; and a selection line that communicatively couples the I3C bus master to the SPI slave device; wherein the I3C bus master and the SPI slave device are to communicate, in accordance with an SPI high data rate (HDR) mode, via the I3C serial data (SDA) line, the I3C serial clock (SCL) line, and the selection line.

Example 10 may include the system of example 9, wherein the SDA line is a slave device input/output (SDI/O) line to convey data between the I3C bus master and the SPI slave device.

Example 11 may include the system of example 9, wherein the selection line is an active low chip select (nCS), an active high chip select (CS), or a slave select (SS) line.

Example 12 may include the system of example 9, wherein the system further comprises a slave data out (SDO) line that communicatively couples the I3C bus master and the SPI slave device, and wherein the I3C bus master is to receive data from the SPI slave device via the SDO line, and the I3C bus master is to transmit data to the SPI slave device via the SDA line.

Example 13 may include the system of any of examples 9-12, wherein the I3C bus master is to enter the SPI HDR mode based on a request received from the SPI slave device.

Example 14 may include the system of any of examples 9-12, wherein the I3C bus master is to transmit, via the SDA line, an indication that the I3C bus is to enter the SPI HDR mode.

Example 15 may include the system of example 14, wherein the I3C bus master is further to transmit, via the SDA line, an indication that the I3C bus is to exit the SPI HDR mode.

Example 16 may include the system of example 15 and/or some other example herein, wherein the indication that the I3C bus is to enter the SPI HDR mode is to cause I3C or inter-integrated circuit (I²C) devices communicatively coupled with the SDA line to become unresponsive to signals on the SDA line until they identify receipt of the indication that the I3C bus master is to exit the SPI HDR mode.

Example 17 may include one or more non-transitory computer-readable media comprising instructions that, when executed by one or more processors of a system that includes an improved inter-integrated circuit (I3C) bus master, cause the I3C bus master to: identify that the I3C bus master is to enter a serial peripheral interface (SPI) high data rate (HDR) mode; and communicate, in accordance with the SPI HDR mode, with an SPI slave device via an I3C bus that includes an I3C serial data (SDA) line, an I3C serial clock (SCL) line, and a selection line.

Example 18 may include the one or more non-transitory computer-readable media of example 17, wherein the instructions are further to cause the I3C bus master to use the SDA line as a slave device input/output (SDI/O) line to transmit data to, and receive data from, the SPI slave device.

Example 19 may include the one or more non-transitory computer-readable media of example 17, wherein the instructions are further to cause the I3C bus master to receive data from the SPI slave device via a slave data out (SDO) line, and wherein the instructions are further to cause the I3C bus master to use the SDA line as a slave device input (SDI) line on which the I3C bus master is to transmit data to the SPI slave device.

Example 20 may include the one or more non-transitory computer-readable media of any of examples 17-19, wherein the instructions are further to cause the I3C bus master to transmit, via the SDA line, an indication that the I3C bus is to enter the SPI HDR mode.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated implementations, including what is described in the Abstract, is not intended to be exhaustive or to limit the embodiments of the present disclosure to the precise forms disclosed. While specific implementations and examples are described herein for illustrative purposes, various equivalent modifications are possible within the scope of the present disclosure, as those skilled in the relevant art will recognize.

These modifications may be made to embodiments of the present disclosure in light of the above detailed description. The terms used in the following claims should not be construed to limit various embodiments of the present disclosure to the specific implementations disclosed in the specification and the claims. Rather, the scope is to be determined entirely by the following claims, which are to be construed in accordance with established doctrines of claim interpretation.

We claim:

1. A system comprising:
one or more processors; and
one or more non-transitory computer-readable media coupled with the one or more processors, wherein the one or more computer-readable media include instructions that, when executed by the one or more processors, cause an improved inter-integrated circuit (I3C) bus master of the system to:
identify that an I3C bus with which the I3C bus master is coupled is to enter a serial peripheral interface (SPI) high data rate (HDR) mode; and
communicate, in accordance with the SPI HDR mode, with an SPI slave device via an I3C serial data (SDA) line, an I3C serial clock (SCL) line, and a selection line.

2. The system of claim 1, wherein the instructions are further to cause the I3C bus master to use the SDA line as a slave device input/output (SDI/0) line to transmit data to, and receive data from, the SPI slave device.

3. The system of claim 1, wherein the selection line is an active low chip select (nCS), an active high chip select (CS), or a slave select (SS) line.

4. The system of claim 1, wherein the instructions are further to cause the I3C bus master to identify data received from the SPI slave device via a slave data out (SDO) line, and wherein the instructions are further to cause the I3C bus master to use the SDA line as a slave device input (SDI) line on which the I3C bus master is to transmit data to the SPI slave device.

5. The system of claim 1, wherein the system is to enter the SPI HDR mode based on a request received from the SPI slave device.

6. The system of claim 1, wherein the instructions are further to cause the I3C bus master to transmit, via the SDA line, an indication that the I3C bus is to enter the SPI HDR mode.

7. The system of claim 6, wherein the instructions are further to cause the I3C bus master to transmit, via the SDA line, an indication that the I3C bus is to exit the SPI HDR mode.

8. The system of claim 7 and/or some other example herein, wherein the indication that the I3C bus is to enter the SPI HDR mode is to cause I3C or inter-integrated circuit (I²C) devices on the SDA line to become unresponsive to signals on the SDA line until they identify receipt of the indication that the I3C bus master is to exit the SPI HDR mode.

9. A system comprising:
a serial peripheral interface (SPI) slave device;
an improved inter-integrated circuit (I3C) bus master; and
an I3C bus that includes:
an I3C serial data (SDA) line that communicatively couples the I3C bus master to the SPI slave device;
an I3C serial clock (SCL) line that communicatively couples the I3C bus master to the SPI slave device; and
a selection line that communicatively couples the I3C bus master to the SPI slave device;
wherein the I3C bus master and the SPI slave device are to communicate, in accordance with an SPI high data rate (HDR) mode, via the I3C serial data (SDA) line, the I3C serial clock (SCL) line, and the selection line.

10. The system of claim 9, wherein the SDA line is a slave device input/output (SDI/0) line to convey data between the I3C bus master and the SPI slave device.

11. The system of claim 9, wherein the selection line is an active low chip select (nCS), an active high chip select (CS), or a slave select (SS) line.

12. The system of claim 9, wherein the system further comprises a slave data out (SDO) line that communicatively couples the I3C bus master and the SPI slave device, and wherein the I3C bus master is to receive data from the SPI slave device via the SDO line, and the I3C bus master is to transmit data to the SPI slave device via the SDA line.

13. The system of claim 9, wherein the I3C bus master is to enter the SPI HDR mode based on a request received from the SPI slave device.

14. The system of claim 9, wherein the I3C bus master is to transmit, via the SDA line, an indication that the I3C bus is to enter the SPI HDR mode.

15. The system of claim 14, wherein the I3C bus master is further to transmit, via the SDA line, an indication that the I3C bus is to exit the SPI HDR mode.

16. The system of claim 15 and/or some other example herein, wherein the indication that the I3C bus is to enter the SPI HDR mode is to cause I3C or inter-integrated circuit (I²C) devices communicatively coupled with the SDA line to become unresponsive to signals on the SDA line until they identify receipt of the indication that the I3C bus master is to exit the SPI HDR mode.

17. One or more non-transitory computer-readable media comprising instructions that, when executed by one or more processors of a system that includes an improved inter-integrated circuit (I3C) bus master, cause the I3C bus master to:
identify that the I3C bus master is to enter a serial peripheral interface (SPI) high data rate (HDR) mode; and
communicate, in accordance with the SPI HDR mode, with an SPI slave device via an I3C bus that includes an I3C serial data (SDA) line, an I3C serial clock (SCL) line, and a selection line.

18. The one or more non-transitory computer-readable media of claim 17, wherein the instructions are further to cause the I3C bus master to use the SDA line as a slave device input/output (SDI/0) line to transmit data to, and receive data from, the SPI slave device.

19. The one or more non-transitory computer-readable media of claim 17, wherein the instructions are further to cause the I3C bus master to receive data from the SPI slave device via a slave data out (SDO) line, and wherein the instructions are further to cause the I3C bus master to use the SDA line as a slave device input (SDI) line on which the I3C bus master is to transmit data to the SPI slave device.

20. The one or more non-transitory computer-readable media of claim 17, wherein the instructions are further to cause the I3C bus master to transmit, via the SDA line, an indication that the I3C bus is to enter the SPI HDR mode.
